(19) United States
(12) Patent Application Publication
(10) Pub. No.: US 2011/0148125 A1
(43) Pub. Date: Jun. 23, 2011

(54) Lever action door latch

(76) Inventor: Frank J. Large, Dallas, TX (US)

(21) Appl. No.: 12/653,830

(22) Filed: Dec. 18, 2009

(51) Int. Cl. E05C 3/16

(52) U.S. Cl. 292/217

(57) ABSTRACT

A door latch includes a latch support, a plurality of lever members, each lever member being rotatably secured to the latch support, a lever actuating handle rotatably secured to a first end of each of the plurality of lever members, and a latch plate. Manually moving the lever actuating handle rotates the plurality of lever members between a substantially vertical position and a substantially horizontal position. The plurality of lever members extend past the edge of the latch support when they are in the substantially horizontal position. For a door which opens inwardly, toward the door latch, the latch support is secured to the door frame and the latch plate is secured to the door. For a door which opens outwardly, away from the door latch, the latch support is secured to the door and the latch plate is secured to the door frame. When the plurality of lever members are in the substantially vertical position, the second end is in the up position and when the plurality of lever members are in the substantially horizontal position, the plurality of lever members are not allowed to go past the substantially horizontal position. In one arrangement, each lever member forms a wing at the first end. The lever actuating handle is rotatably secured to the wing of each lever member of the plurality of lever members. In this way, the plurality of lever members cannot go past the substantially horizontal position.

### CROSS-REFERENCE TO RELATED APPLICATIONS

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates generally to door locks and door latches, and in particular to auxiliary door locks and door latches.

2. Description of Related Art

Door chains are handy but are easily broken by force. Dead bolts are difficult for people without a drill and a good set of tools to install. The present invention provides a secure auxiliary lock which can be installed with just a screw driver.

### BRIEF SUMMARY OF THE INVENTION

A door latch according to the present invention includes a latch support, a plurality of lever members, each lever member being rotatably secured to the latch support, a lever actuating handle rotatably secured to a first end of each of the plurality of lever members, and a latch plate. The latch support can be secured to a door or a door frame and the latch plate can be secured to a door or a door frame. Manually moving the lever actuating handle rotates the plurality of lever members between a substantially vertical position and a substantially horizontal position. The second end of each of the plurality of lever members extends past the edge of the latch support when they are in the substantially horizontal position.

For a door which opens inwardly, toward the door latch, the latch support is secured to the door frame and the latch plate is secured to the door. The latch plate is in a location to engage the second ends of the plurality of lever members when the lever members are substantially horizontal, thus preventing the door from opening. For a door which opens outwardly, away from the door latch, the latch support is secured to the door and the latch plate is secured to the door frame in a location to engage the second ends of the plurality of lever members when the lever members are substantially horizontal, thus preventing the door from opening.

In a preferred arrangement, when the plurality of lever members are in the substantially vertical position, the second end is in the up position with respect to the first end and when the plurality of lever members are in the substantially horizontal position, the plurality of lever members are not allowed to go past the substantially horizontal position, in which the first end would be in the up position.

In a preferred arrangement, each lever member of the plurality of lever members forms a wing at the first end. The lever actuating handle is rotatably secured to the wing of each lever member of the plurality of lever members. When the plurality of lever members are in the substantially vertical position, the second end is in the up position with respect to the first end and when the plurality of lever members are in the substantially horizontal position, the wings are in the up position with respect to the rest of the first end of the plurality of lever members. In this way, the plurality of lever members cannot go past the substantially horizontal position, in which the first end would be in the up position.

These and other objects, advantages and features of this invention will be apparent from the following description taken with reference to the accompanying drawing, wherein is shown a preferred embodiment of the invention.

### BRIEF DESCRIPTION OF THE SEVERAL VIEWS OF THE DRAWING

FIG. 1 is a door latch according to the present invention installed on an inwardly swinging door;

FIG. 2 is the door latch of FIG. 1 in the unlocked position and with the face plate removed;

FIG. 3 is the door latch of FIG. 1 in the locked position and with the face plate removed; and

FIG. 4 is an alternative embodiment of a door latch according to the present invention, in the locked position and with the face plate removed.

### DETAILED DESCRIPTION OF THE INVENTION

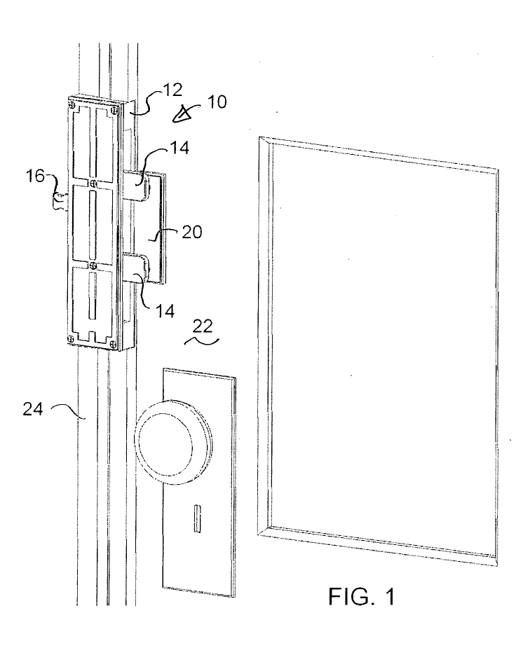

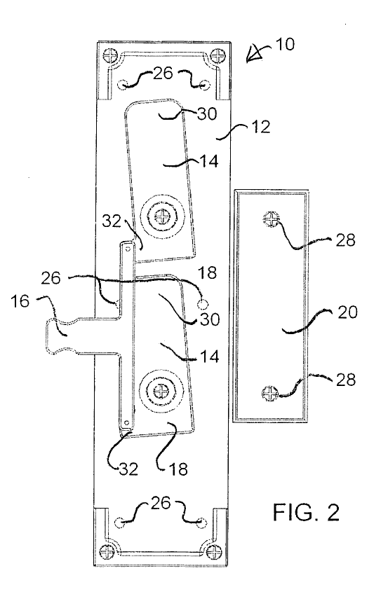

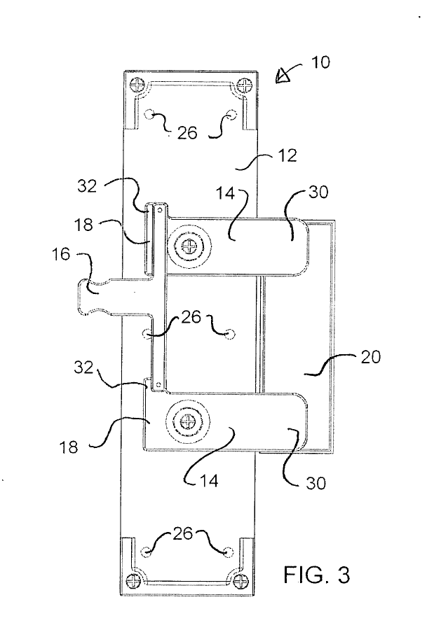

Referring now to the drawing, and in particular to FIG. 1, FIG. 2 and FIG. 3, a door latch according to the present invention is referred to generally by reference numeral 10. Door latch 10 includes a latch support 12, a plurality of lever members 14, each lever member being rotatably secured to the latch support, a lever actuating handle 16 rotatably secured to a first end 18 of each of the plurality of lever members, and a latch plate 20. Latch support 12 can be secured to a door 22 or a door frame 24, preferably by long screws 26 which would go all the way into the stud when mounted on door frame 24. Similarly, latch plate 20 can be secured to door 22 or door frame 24, preferably by screws 28, although any attempt to force entry would simply tighten latch plate 20. Manually moving lever actuating handle 16 rotates the plurality of lever members 14 between an unlocked, substantially vertical position shown in FIG. 2 and a locked, substantially horizontal position shown in FIG. 1 and FIG. 3. The second end 30 of each of the plurality of lever members extends past the edge of the latch support when they are in the substantially horizontal position so as to engage the latch plate.

For a door such as door 22 which opens inwardly, toward the door latch, latch support 12 is secured to door frame 24 and latch plate 20 is secured to door 22. Latch plate 20 is in a location to engage the second ends 30 of the plurality of lever members 14 when the lever members are substantially horizontal, thus preventing the door from opening. For a door which opens outwardly, away from the door latch, the latch support is secured to the door and the latch plate is secured to the door frame in a location to engage the second ends of the plurality of lever members when the lever members are substantially horizontal, thus preventing the door from opening.

Referring specifically to FIG. 2, in a preferred arrangement, when the plurality of lever members are in the substantially vertical position, second end 30 is in the up position with respect to first end 18 and, referring specifically to FIG. 3, when the plurality of lever members are in the substantially horizontal position, the plurality of lever members are not allowed to go past the substantially horizontal position, in which the first end would be in the up position.

In a preferred arrangement, each lever member 14 of the plurality of lever members forms a wing 32 at first end 18. Lever actuating handle 16 is rotatably secured to the wing of each lever member of the plurality of lever members. When the plurality of lever members are in the substantially vertical position, the second end is in the up position with respect to the first end and when the plurality of lever members are in the substantially horizontal position, the wings are in the up position with respect to the rest of the first end of the plurality of lever members. In this way, the plurality of lever members cannot go past the substantially horizontal position, in which the first end would be in the up position.

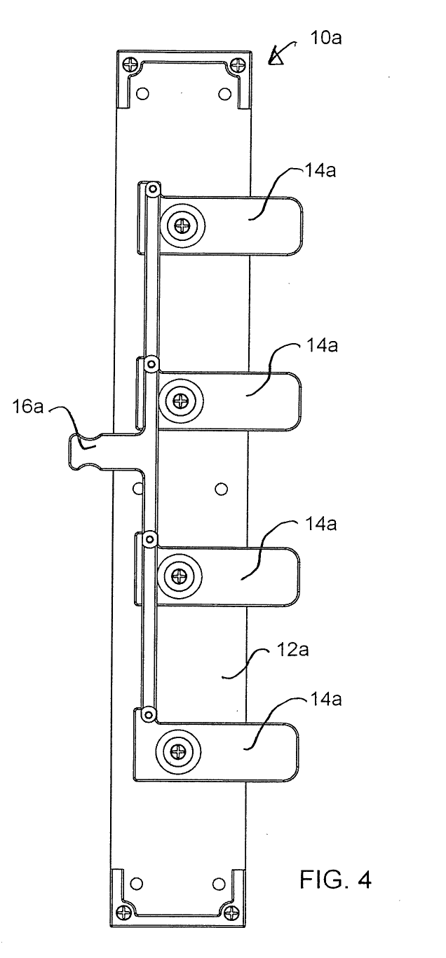

Referring now to FIG. 4, an alternative embodiment of a door latch according to the present invention is referred to generally by reference numeral 10a. Door latch 10a includes a latch support 12a, a plurality of lever members 14a, each lever member being rotatably secured to the latch support, a lever actuating handle 16a rotatably secured to a first end 18a of each of the plurality of lever members, and a latch plate, not shown. Door latch 12a operates exactly the same as door latch 12 and merely illustrates that the number of lever members can more than two and still function the same.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A door latch, comprising in combination:
a latch support, wherein the latch support can be secured to a door or a door frame;
a plurality of lever members, each lever member being rotatably secured to the latch support;
a lever actuating handle rotatably secured to a first end of each of the plurality of lever members, whereby manually moving the lever actuating handle rotates the plurality of lever members between a substantially vertical position and a substantially horizontal position, and wherein the second end of each of the plurality of lever members extends past the edge of the latch support; and
a latch plate, wherein the latch plate can be secured to a door or a door frame, and wherein for a door which opens inwardly, toward the door latch, the latch support is secured to the door frame and the latch plate is secured to the door in a location to engage the second ends of the plurality of lever members when the lever members are substantially horizontal, thus preventing the door from opening, and wherein for a door which opens outwardly, away from the door latch, the latch support is secured to the door and the latch plate is secured to the door frame in a location to engage the second ends of the plurality of lever members when the lever members are substantially horizontal, thus preventing the door from opening.

2. A door latch according to claim 1, wherein each lever member of the plurality of lever members forms a wing at the first end, wherein the lever actuating handle is rotatably secured to the wing of each lever member of the plurality of lever members.

3. A door latch according to claim 2, wherein when the plurality of lever members are in the substantially vertical position, the second end is in the up position with respect to the first end and when the plurality of lever members are in the substantially horizontal position, the wings are in the up position with respect to the rest of the first end of the plurality of lever members, whereby the plurality of lever members cannot go past the substantially horizontal position, in which the first end would be in the up position.

4. A door latch according to claim 1, wherein when the plurality of lever members are in the substantially vertical position, the second end is in the up position with respect to the first end and when the plurality of lever members are in the substantially horizontal position, the plurality of lever members are not allowed to go past the substantially horizontal position, in which the first end would be in the up position.
